(19) United States
(12) Patent Application Publication
(10) Pub. No.: US 2025/0316077 A1
(43) Pub. Date: Oct. 9, 2025

(54) INFORMATION PROCESSING APPARATUS, INFORMATION PROCESSING METHOD, AND NON-TRANSITORY RECORDING MEDIUM

(71) Applicant: NEC Corporation, Minato-ku, Tokyo (JP)

(72) Inventor: Takuma AMADA, Tokyo (JP)

(73) Assignee: NEC Corporation, Minato-ku, Tokyo (JP)

(21) Appl. No.: 18/867,927

(22) PCT Filed: May 24, 2022
(86) PCT No.: PCT/JP2022/021241

§ 371 Date: Nov. 21, 2024

(51) Int. Cl. G06V 10/98; G06V 10/74; G06V 40/10

(52) U.S. Cl. CPC G06V 10/98; G06V 10/761; G06V 40/10

(57) ABSTRACT

An information processing apparatus includes: a perturbing position determination unit that determines an element serving as a perturbing target in first information; a perturbing unit that applies a perturbation with magnitude based on values of one or more elements surrounding the element serving as the perturbing target, to the element serving as the perturbing target; and an assessment unit that assesses a risk in authentication processing based on a result of the authentication processing of matching the first information to which the perturbation is applied, with second information that is different from the first information.

### TECHNICAL FIELD

This disclosure relates to technical fields of an information processing apparatus, an information processing method, and a recording medium.

### BACKGROUND ART

Patent Literature 1 describes a learning device that determines a parameter of an identification model for classifying input data into any of a plurality of classes includes units for: acquiring a set of training data in supervised training; applying perturbation in a direction of maximizing a loss function to the input data in each piece of the training data; and deriving a parameter for minimizing the loss function, and describes a technique/technology of determining a maximum allowable amount of perturbation for each class according to importance of the class. Patent Literature 2 describes a technique/technology of: identifying a robustness strength required by a computation device using a learned model, the robustness strength being with respect to an adversarial sample, which is an input signal to which a perturbation has been added in order to induce an erroneous assessment in the learned model; and determining a noise removal strength for the input signal, on the basis of the robustness strength. Patent Literature 3 describes a technique/technology of: calculating similarity between a feature quantity of an input to an authentication model and a feature quantity of a template; estimating a local Lipschitz constant of a function, which calculates the similarity between the feature quantity of the input to the authentication model and the feature quantity of the template, in a sphere with the input to the authentication model as the center; and estimating an evaluation value of the robustness of the authentication model on the basis of the similarity, a determination threshold for the similarity, and the local Lipschitz constant. Patent Literature 4 describes a technique/technology of: acquiring a plurality of adversarial perturbations due to a difference between a face image and an adversarial sample based on the face image; and generating a filter on the basis of the plurality of adversarial perturbations.

### CITATION LIST

### Patent Literature

Patent Literature 1: JP2021-022316A
Patent Literature 2: International Publication No. WO2020/230699
Patent Literature 3: International Publication No. WO2021/038788
Patent Literature 4: International Publication No. WO2021/131029

### SUMMARY

### Technical Problem

It is an example object of this disclosure to provide an information processing apparatus, an information processing method, and a recording medium that aim to improve the techniques/technologies disclosed in Citation List.

### Solution to Problem

An information processing apparatus according to an example aspect of this disclosure includes: a perturbing position determination unit that determines an element serving as a perturbing target in first information; a perturbing unit that applies a perturbation with magnitude based on values of one or more elements surrounding the element serving as the perturbing target, to the element serving as the perturbing target; and an assessment unit that assesses a risk in authentication processing based on a result of the authentication processing of matching the first information to which the perturbation is applied, with second information that is different from the first information.

An information processing method according to an example aspect of this disclosure includes: determining an element serving as a perturbing target in first information; applying a perturbation with magnitude based on values of one or more elements surrounding the element serving as the perturbing target, to the element serving as the perturbing target; and assessing a risk in authentication processing based on a result of the authentication processing of matching the first information to which the perturbation is applied, with second information that is different from the first information.

A recording medium according to an example aspect of this disclosure is a recording medium on which a computer program that allows at least one computer to execute an information processing method is recorded, the information processing method including: determining an element serving as a perturbing target in first information; applying a perturbation with magnitude based on values of one or more elements surrounding the element serving as the perturbing target, to the element serving as the perturbing target; and assessing a risk in authentication processing based on a result of the authentication processing of matching the first information to which the perturbation is applied, with second information that is different from the first information.

### BRIEF DESCRIPTION OF DRAWINGS

FIG. 1 is a block diagram illustrating a configuration of an information processing apparatus according to a first example embodiment.

FIG. 2 is a block diagram illustrating a configuration of an information processing apparatus according to a second example embodiment.

FIG. 3 is a flowchart illustrating a flow of an information processing operation performed by the information processing apparatus according to the second example embodiment.

FIG. 4 is a conceptual diagram illustrating an information processing operation performed by an information processing apparatus according to a fourth example embodiment.

FIG. 5 is a block diagram illustrating a configuration of an information processing apparatus according to a fifth example embodiment.

FIG. 6 is a flowchart illustrating a flow of operation of the information processing apparatus according to the fifth example embodiment.

FIG. 7 is a flowchart illustrating a flow of a perturbing position determination operation by an information processing apparatus according to a sixth example embodiment.

FIG. 8 is a flowchart illustrating a flow of a perturbing position determination operation by an information processing apparatus according to a seventh example embodiment.

FIG. 9 is a flowchart illustrating a flow of a perturbing position determination operation by an information processing apparatus according to an eighth example embodiment.

FIG. 10 is a flowchart illustrating a flow of a risk assessment operation by an information processing apparatus according to a ninth example embodiment.

### DESCRIPTION OF EXAMPLE EMBODIMENTS

With reference to the drawings, an information processing apparatus, an information processing method, and an example embodiment of a recording medium will be described.

### 1: First Example Embodiment

An information processing apparatus, an information processing method, and a recording medium according to a first example embodiment will be described. The following describes the information processing apparatus, the information processing method, and the recording medium according to the first example embodiment, by using an information processing apparatus 1 to which the information processing apparatus, the information processing method, and the recording medium according to the first example embodiment are applied.

### 1-1: Configuration of Information Processing Apparatus 1

With reference to FIG. 1, a configuration of an information processing apparatus 1 according to the first example embodiment will be described. FIG. 1 is a block diagram illustrating the configuration of the information processing apparatus 1 according to the first example embodiment.

As illustrated in FIG. 1, the information processing apparatus 1 includes a perturbing position determination unit 11, a perturbing unit 12, and an assessment unit 13. The perturbing position determination unit 11 determines an element serving as a perturbing target in first information. The perturbing unit 12 perturbs a perturbation with magnitude based on values of one or more elements surrounding the element serving as the perturbing target, to the element serving as the perturbing target. The assessment unit 13 assesses a risk in authentication processing on the basis of a result of the authentication processing of matching the perturbed first information with second information that is different from the first information.

### 1-2: Technical Effect of Information Processing Apparatus 1

The information processing apparatus 1 according to the first example embodiment applies a perturbation with the magnitude based on the values of the elements surrounding the element serving as the perturbing target, to the element serving as the perturbing target. Since the magnitude of the perturbation applied by the information processing apparatus 1 is based on the values of the elements surrounding the element serving as the perturbing target, the applied perturbation is hardly perceived. The information processing apparatus 1 is capable of assessing the risk in the authentication processing on the basis of a result of the authentication processing using a perturbed adversarial sample in which the applied perturbation is hardly perceived.

### 2: Second Example Embodiment

An information processing apparatus, an information processing method, and a recording medium according to a second example embodiment will be described. The following describes the information processing apparatus, the information processing method, and the recording medium according to the second example embodiment, by using an information processing apparatus 2 to which the information processing apparatus, the information processing method, and the recording medium according to the second example embodiment are applied.

### 2-1: Configuration of Information Processing Apparatus 2

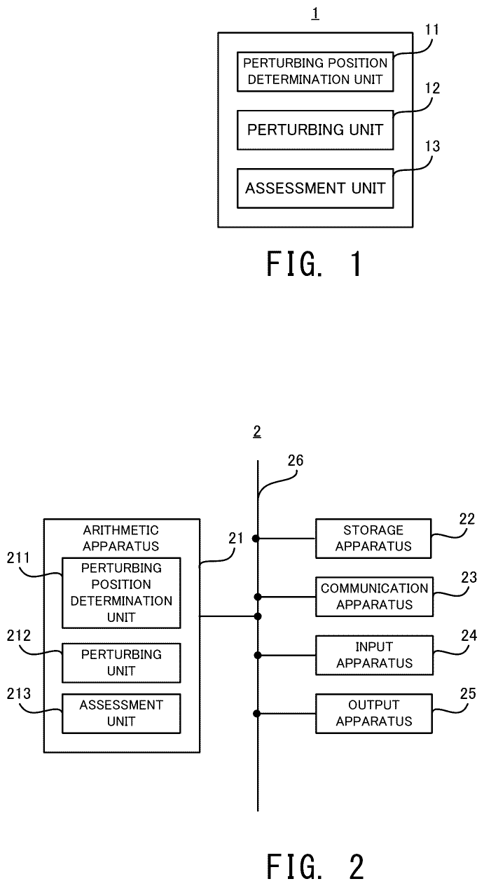

With reference to FIG. 2, a configuration of the information processing apparatus 2 according to the second example embodiment will be described. FIG. 2 is a block diagram illustrating the configuration of the information processing apparatus 2 according to the second example embodiment.

As illustrated in FIG. 2, the information processing apparatus 2 includes an arithmetic apparatus 21 and a storage apparatus 22. Furthermore, the information processing apparatus 2 may include a communication apparatus 23, an input apparatus 24, and an output apparatus 25. The information processing apparatus 2, however, may not include at least one of the communication apparatus 23, the input apparatus 24, and the output apparatus 25. The arithmetic apparatus 21, the storage apparatus 22, the communication apparatus 23, the input apparatus 24, and the output apparatus 25 may be connected through a data bus 26.

The arithmetic apparatus 21 includes at least one of a CPU (Central Processing Unit), a GPU (Graphics Processing Unit), and a FPGA (Field Programmable Gate Array), for example. The arithmetic apparatus 21 reads a computer program. For example, the arithmetic apparatus 21 may read a computer program stored in the storage apparatus 22. For example, the arithmetic apparatus 21 may read a computer program stored by a computer-readable and non-transitory recording medium, by using a not-illustrated recording medium reading apparatus provided in the information processing apparatus 2 (e.g., the input apparatus 24 described later). The arithmetic apparatus 21 may acquire (i.e., download or read) a computer program from a not-illustrated apparatus disposed outside the information processing apparatus 2, via the communication apparatus 23 (or another communication apparatus). The arithmetic apparatus 21 executes the read computer program. Consequently, a logical functional block for performing an operation to be performed by the information processing apparatus 2 is realized or implemented in the arithmetic apparatus 21. That is, the arithmetic apparatus 21 is allowed to function as a controller for realizing or implementing the logical functional block for performing an operation (in other words, processing) to be performed by the information processing apparatus 2.

FIG. 2 illustrates an example of the logical functional block realized or implemented in the arithmetic apparatus 21 to perform an information processing operation. As illustrated in FIG. 2, a perturbing position determination unit 211 that is a specific example of the “perturbing position determination unit” described in Supplementary Note later, a perturbing unit 212 that is a specific example of the “perturbing unit” described in Supplementary Note later, and an assessment unit 213 that is a specific example of the “risk assessment unit” described in Supplementary Note later, are realized or implemented in the arithmetic apparatus 21.

The perturbing position determination unit 211 determines at least one element to be perturbed, from a plurality of elements included in the first information, for example. The “perturbation” here is a noise applied to increase a degree of similarity between the first information and the second information. A more specific techniques/technology when determining the element serving as the perturbing target will be described in detail in another example embodiment later.

The perturbing unit 212 is configured to perturb a perturbation to the element determined by the perturbing position determination unit 211. That is, the perturbing unit 212 is configured to generate the perturbed first information (hereinafter referred to as “adversarial sample” as appropriate) by perturbing a part of the elements of the first information.

The assessment unit 213 is configured to assess a risk in authentication processing (in other words, a potential risk in an authentication model or an authenticator that performs the authentication processing). More specifically, the assessment unit 213 assesses the risk in the authentication processing on the basis of a result of the authentication processing using the adversarial sample generated by the perturbing unit 212. For example, the assessment unit 213 may assess a possibility that the generated adversarial sample (i.e., the perturbed first information) is recognized as the second information. A specific assessment method by the assessment unit 213 will be described in detail in another example embodiment later.

The assessment unit 213 may be provided separately from an apparatus that generates the adversarial sample. For example, an adversarial sample generation apparatus including the perturbing position determination unit 211 and the perturbing unit 212, and a risk assessment apparatus including the assessment unit 213 may be configured as separate apparatuses.

The authentication processing may be performed by an authentication apparatus provided separately from the information processing apparatus 2 according to the second example embodiment. In this case, the adversarial sample generated by the perturbing unit 212 may be outputted to the authentication apparatus, and the assessment unit 213 may assess the risk using an authentication result inputted from the authentication apparatus. Alternatively, the assessment unit 213 may have a function of performing the authentication processing. That is, the assessment unit 213 may be configured to perform the authentication processing by itself and assess the risk in the authentication processing on the basis of the authentication result.

The storage apparatus 22 is configured to store desired data. For example, the storage apparatus 22 may temporarily store a computer program to be executed by the arithmetic apparatus 21. The storage apparatus 22 may temporarily store data that are temporarily used by the arithmetic apparatus 21 when arithmetic apparatus 21 executes the computer program. The storage apparatus 22 may store data that are stored by the information processing apparatus 2 for a long time. The storage apparatus 22 may include at least one of a RAM (Random Access Memory), a ROM (Read Only Memory), a hard disk apparatus, a magneto-optical disk apparatus, a SSD (Solid State Drive), and a disk array apparatus. That is, the storage apparatus 22 may include a non-transitory recording medium.

The communication apparatus 23 is configured to communicate with an apparatus external to the information processing apparatus 2 via a not-illustrated communication network.

The input apparatus 24 is an apparatus that receives an input of information to the information processing apparatus 2 from an outside of the information processing apparatus 2. For example, the input apparatus 24 may include an operating apparatus (e.g., at least one of a keyboard, a mouse, and a touch panel) that is operable by an operator of the information processing apparatus 2. For example, the input apparatus 24 may include a reading apparatus that is configured to read information recorded as data on a recording medium that is externally attachable to the information processing apparatus 2.

The output apparatus 25 is an apparatus that outputs information to the outside of the information processing apparatus 2. For example, the output apparatus 25 may output information as an image. That is, the output apparatus 25 may include a display apparatus (a so-called display) that is configured to display an image indicating the information that is desirably outputted. For example, the output apparatus 25 may output information as audio/sound. That is, the output apparatus 25 may include an audio apparatus (a so-called speaker) that is configured to output audio/sound. For example, the output apparatus 25 may output information onto a paper surface. That is, the output apparatus 25 may include a print apparatus (a so-called printer) that is configured to print desired information on the paper surface.

### 2-2: Information Processing Operation Performed by Information Processing Apparatus 2

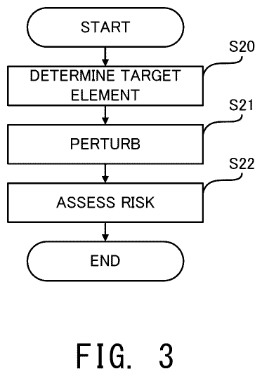

With reference to FIG. 3, a flow of an information processing operation performed by the information processing apparatus 2 according to the second example embodiment will be described. FIG. 3 is a flowchart illustrating the flow of the information processing operation performed by the information processing apparatus 2 according to the second example embodiment.

As illustrated in FIG. 3, the perturbing position determination unit 211 determines an element serving as the perturbing target in the first information (hereinafter referred to as a “target element” in some cases) (step S20).

The perturbing unit 212 applies to the target element the perturbation with magnitude based on values of one or more elements surrounding the target element (step S21). The perturbing unit 212 may determine the magnitude of the perturbation applied to the target element (hereinafter referred to as a “perturbation size” in some cases) such that a difference between the perturbation size and a calculated value calculated on the basis of the values of the elements surrounding the target element (hereinafter simply referred to as a “calculated value” in some cases) is less than or equal to a predetermined value, and may apply the perturbation of the perturbation size to the target element. In this case, the magnitude of the perturbation applied by the perturbing unit 212 may vary depending on the calculated value and the predetermined value. For example, as the predetermined value is set smaller, the perturbing unit 212 may determine the perturbation size to be a size close to the calculated value. For example, when the predetermined value is set relatively small and the calculated value is relatively small, the perturbing unit 212 may determine the perturbation size to be a relatively small size. For example, when the predetermined value is set relatively small and the calculated value is relatively large, the perturbing unit 212 may determine the perturbation size to be a relatively large size.

The assessment unit 213 assesses the risk in the authentication processing on the basis of a result of the authentication processing of matching the perturbed first information with the second information that is different from the first information (step S22).

### 2-3: Technical Effect of Information Processing Apparatus 2

The information processing apparatus 2 according to the second example embodiment determines the perturbation size such that the difference between the calculated value calculated on the basis of the values of the elements surrounding the target element and the perturbation size of the perturbation applied to the target element is less than or equal to the predetermined value, and applies the perturbation of the perturbation size to the target element. Since the perturbation size of the perturbation applied by the information processing apparatus 2 is determined such that the difference from the calculated value calculated on the basis of the values of the elements surrounding the target element is less than or equal to the predetermined value, the applied perturbation is hardly perceived. The information processing apparatus 2 is capable of assessing the risk in the authentication processing on the basis of the result of the authentication processing using the perturbed adversarial sample in which the applied perturbation is hardly perceived.

### 3: Third Example Embodiment

An information processing apparatus, an information processing method, and a recording medium according to a third example embodiment will be described. The following describes the information processing apparatus, the information processing method, and the recording medium according to the third example embodiment, by using an information processing apparatus 3 to which the information processing apparatus, the information processing method, and the recording medium according to the third example embodiment are applied.

In the third example embodiment, the perturbing unit 212 may apply the perturbation with magnitude based on a mean value of the elements surrounding the element serving as the perturbing target, to the element serving as the perturbing target. The perturbing unit 212 may determine the perturbation size such that a difference between the perturbation size and the mean value of elements surrounding the target element is less than or equal to a predetermined value, and may apply the perturbation of the perturbation size to the target element. The perturbing unit 212 may determine the perturbation size according to the following Equation 1, and may apply the perturbation of the perturbation size to the target element.

$$\vert {δ}_{ij} - x \vert \leq Δ \qquad [ Equation 1 ]$$

That is, the perturbing unit 212 may determine the perturbation size such that a difference between a perturbation size δᵢⱼ and a mean value of a plurality of elements X (elements included in Aᵢⱼ (element set)) surrounding a target element Xᵢⱼ is less than or equal to a predetermined value Δ, and may apply the perturbation of the perturbation size to the target element. The predetermined value Δ may be set in a range of possible values of the element X. For example, when the element X can take a value of 0 to 1, the predetermined value Δ may be set in a range of 0 to 1. In this case, the predetermined value Δ may be set to 0.3, 0.5, 0.8, or the like. The predetermined value Δ may be set to a value that allows a favorable result, on the basis of experimental results, for example.

### Technical Effect of Information processing Apparatus 3

Since the information processing apparatus 3 according to the third example embodiment may include, in the perturbation size, the plurality of elements surrounding the target element in an equal condition, the perturbation applied to the target element is hardly perceived.

### 4: Fourth Example Embodiment

An information processing apparatus, an information processing method, and a recording medium according to a fourth example embodiment will be described. The following describes the information processing apparatus, the information processing method, and the recording medium according to the fourth example embodiment, by using an information processing apparatus 4 to which the information processing apparatus, the information processing method, and the recording medium according to the fourth example embodiment are applied.

In the fourth example embodiment, the first information may be a first image including a first living body, and the second information may be a second image including a second living body. For example, the first information and the second information may be images of a person.

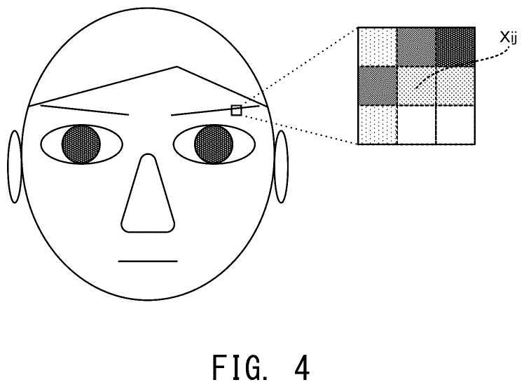

FIG. 4 is a conceptual diagram illustrating an information processing operation performed by the information processing apparatus 4 according to the fourth example embodiment. As illustrated in FIG. 4, the perturbing unit 212 may apply, to a pixel Xᵢⱼ serving as the target element, the perturbation with magnitude based on pixel values of pixels surrounding the pixel Xᵢⱼ. The perturbing unit 212 may determine the perturbation size of the perturbation applied to the pixel Xᵢⱼ such that a difference between a calculated value calculated on the basis of the pixel values of the pixels surrounding the pixel Xᵢⱼ and the perturbation size of the perturbation applied to the pixel Xᵢⱼ is less than or equal to a predetermined value, and may apply the perturbation of the perturbation size to the pixel Xᵢⱼ. The perturbing unit 212 may apply to the pixel Xᵢⱼ the perturbation with magnitude based on a mean value of the pixel values of a plurality of pixels surrounding the pixel Xᵢⱼ. For example, the perturbing unit 212 may adopt the mean value of the pixel values of the plurality of pixels surrounding the pixel Xᵢⱼ, as the calculated value calculated on the basis of the pixel values of the pixels surrounding the pixel Xᵢⱼ. That is, the perturbing unit 212 may determine the perturbation size, for example, in accordance with Equation 1, and may apply the perturbation of the perturbation size to the target element. Alternatively, for example, the perturbing unit 212 may apply a predetermined weight to the pixel value of a pixel that is in a predetermined positional relation with the pixel Xᵢⱼ, and may calculate the calculated value based on the pixel values of the surrounding pixels.

FIG. 4 illustrates, as the pixels surrounding the pixel Xᵢⱼ, eight pixels surrounding the pixel Xᵢⱼ (pixels included in an area of 3 pixels×3 pixels centered on the pixel Xᵢⱼ), but not limited to this, the perturbing unit 212 may arbitrarily determine the pixel to be employed as the surrounding pixels. For example, the perturbing unit 212 may adopt pixels included in an area of 5 pixels×5 pixels centered on the pixel Xᵢⱼ as the surrounding pixels, or may adopt pixels included in an area of 7 pixels×7 pixels centered on the pixel Xᵢⱼ as the surrounding pixels. Alternatively, the perturbing unit 212 may adopt four pixels located upper, lower, and left and right sides of the pixel Xᵢⱼ as the surrounding pixels. Alternatively, the perturbing unit 212 may adopt three or less pixels adjacent to the pixel Xᵢⱼ as the surrounding pixels.

With reference to FIG. 4, the first information and the second information are face images including a face of a living body, but the first information and the second information may be iris images including an iris of the living body, or images including another part of the living body, for example.

### Technical Effect of Information processing Apparatus 4

The information processing apparatus 4 according to the fourth example embodiment is capable of properly assessing the risk in the authentication processing using the image. For example, it is possible to properly assess the risk to an adversarial input, in face authentication using the face image and iris authentication using the iris image.

### 5: Fifth Example Embodiment

An information processing apparatus, an information processing method, and a recording medium according to a fifth example embodiment will be described. The following describes the information processing apparatus, the information processing method, and the recording medium according to the fifth example embodiment, by using an information processing apparatus 5 to which the information processing apparatus, the information processing method, and the recording medium according to the fifth example embodiment are applied.

### 5-1: Configuration of Information processing Apparatus 5

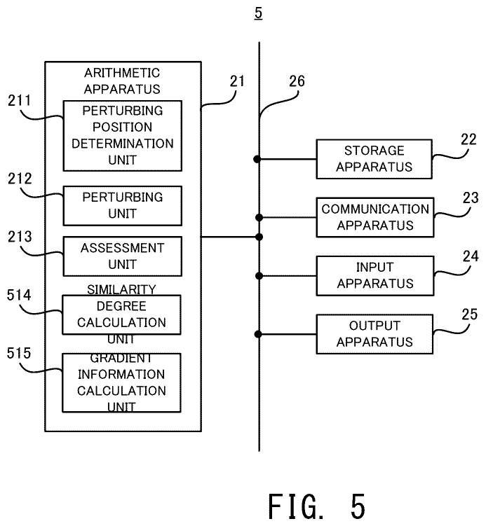

With reference to FIG. 5, a configuration of the information processing apparatus 5 according to the fifth example embodiment will be described. FIG. 5 is a block diagram illustrating the configuration of the information processing apparatus 5 according to the fifth example embodiment.

As illustrated in FIG. 5, the information processing apparatus 5 according to the fifth example embodiment includes the arithmetic apparatus 21 and the storage apparatus 22, as in the information processing apparatus 2 according to the second example embodiment. Furthermore, the information processing apparatus 5 may include the communication apparatus 23, the input apparatus 24, and the output apparatus 25, as in the information processing apparatus 2 in the second example embodiment. The information processing apparatus 5, however, may not include at least one of the communication apparatus 23, the input apparatus 24, and the output apparatus 25. The information processing apparatus 5 according to the fifth example embodiment is different from the information processing apparatus 2 according to the second example embodiment to the information processing apparatus 4 according to the fourth example embodiment, in that the arithmetic apparatus 21 includes a similarity degree calculation unit 514 and a gradient information calculation unit 515. Other features of the information processing apparatus 5 may be the same as those of at least one of the information processing apparatus 2 according to the second example embodiment to the information processing apparatus 4 according to the fourth example embodiment.

The similarity degree calculation unit 514 is configured such that a feature quantity of the first information (hereinafter referred to as a “first information feature quantity” as appropriate) and a feature quantity of the second information (hereinafter referred to as a “second information feature quantity” as appropriate) are inputted thereto. Then, the similarity degree calculation unit 514 is configured to calculate a degree of similarity between the inputted first information feature quantity and second information feature quantity. A method of calculating the degree of similarity is not particularly limited, and existing techniques/technologies may be employed as appropriate. The degree similarity may be a matching score obtained by matching the first information feature quantity with the second information feature quantity. A specific example of the first information and the second information will be described in detail in another example embodiment later.

The gradient information calculation unit 515 is configured to calculate gradient information indicating a gradient of the degree of similarity calculated by the similarity degree calculation unit 514. A method of calculating the gradient information is not particularly limited, and the existing techniques/technologies may be employed as appropriate. The gradient information may be information including a Jacobian of the degree of similarity. For example, when the degree of similarity between the first information feature quantity f(Xa) and the second information feature quantity f(Xt) is set to L{f(Xa), f(Xt)}, the gradient information ∇L(Xa,Xt) may be calculated as illustrated in the following Equation 2.

$$∇ ( {X}_{a} , {X}_{t} ) = {[ \frac{\partial ( f ( {X}_{a} ) , f ( {X}_{t} ) )}{\partial {X}_{{a}_{i}}} ]}_{i = 1 , ... M} \qquad [ Equation 2 ]$$

wherein M is the dimensionality of X.

In the fifth example embodiment, the perturbing position determination unit 211 is configured to determine the element serving as the perturbing target in the first information, on the basis of the gradient information calculated by the gradient information calculation unit 515. For example, a case where that the gradient information indicated by described Equation (2) is positive, means that the degree of similarity between the first information and the second information is increased by perturbing the element Xa.

The perturbing unit 212 is configured to generate the adversarial sample by perturbing a part of the elements of the first information. In a case of using the adversarial sample generated in this way, for example, the degree of similarity between the first information and the second information is higher than that in a case of not applying the perturbation. That is, the adversarial sample generated by the perturbing unit 212 is easily misrecognized as the second information by mistake in the authentication processing.

The assessment unit 213 in the fifth example embodiment may be provided separately from an apparatus that generates the adversarial sample. For example, an adversarial sample generation apparatus including the similarity degree calculation unit 514, the gradient information calculation unit 515, the perturbing position determination unit 211, and the perturbing unit 212, and a risk assessment apparatus including the assessment unit 213 may be configured as separate apparatuses.

### 5-2: Information processing Operation Performed by Information processing Apparatus 5

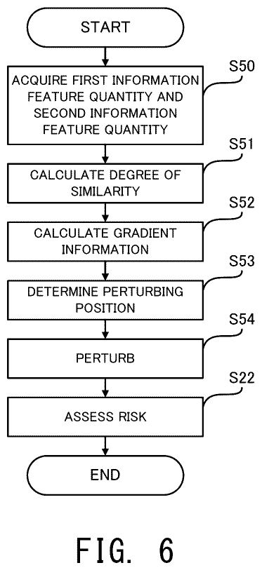

Next, with reference to FIG. 6, a flow of overall operation performed by the information processing apparatus 5 according to the fifth example embodiment will be described. FIG. 6 is a flowchart illustrating the operation flow of the information processing apparatus according to the fifth example embodiment.

As illustrated in FIG. 6, when the operation of the information processing apparatus 5 according to the fifth example embodiment is started, first, the similarity degree calculation unit 514 acquires the first information feature quantity and the second information feature quantity (step S50). Then, the similarity degree calculation unit 514 calculates the degree of similarity between the acquired first information feature quantity and second information feature quantity (step S51). Information about the degree of similarity calculated by the similarity degree calculation unit 514 is outputted to the gradient information calculation unit 515.

Subsequently, the gradient information calculation unit 515 computes the gradient information indicating the gradient of the degree of similarity degree calculated by the similarity degree calculation unit 514 (step S52). The gradient information calculated by the gradient information calculating unit 515 is outputted to the perturbing position determination unit 211.

Subsequently, the perturbing position determination unit 211 determines the element to be perturbed in the first information, on the basis of the gradient information calculated by the gradient information calculation unit 515 (step S53). Information about the element determined by the perturbing position determination unit 211 is outputted to the perturbing unit 212.

Subsequently, the perturbing unit 212 perturbs the element determined by the perturbing position determination unit 211 (step S54). That is, the first information is perturbed to generate the adversarial sample. The adversarial sample generated by the perturbing unit 212 is used in the authentication processing.

Subsequently, the assessment unit 213 assesses the risk in the authentication processing on the basis of the result of the authentication processing of matching the perturbed first information with the second information that is different from the first information (step S22). The assessment unit 213 may assess the risk in the authentication processing on the basis of the authentication result of the authentication processing using the adversarial sample generated by the perturbing unit 212. The assessment unit 213 may output a risk assessment result.

### 5-3: Technical Effect of Information processing Apparatus 5

Next, a technical effect obtained by the information processing apparatus 5 according to the fifth example embodiment will be described.

As described in FIG. 5 to FIG. 6, in the information processing apparatus 5 according to the fifth example embodiment, the perturbation is applied on the basis of the degree of similarity between the two pieces of information, thereby generating the adversarial sample. The risk in the authentication processing is assessed on the basis of the result of the authentication processing using the generated adversarial sample. In this way, it is possible to properly assess the risk in the authentication processing to an adversarial input. Specifically, it is possible to assess what type of risk is included in the authentication processing, to an attack aiming to intentionally obtain an incorrect result.

For a method of generating the adversarial sample, JSMA (Jacobian-base Saliency Map Attack) is known. This method assumes class-classification processing (i.e., processing in which a classification probability vector is obtained as a processing result), and thus, it cannot be directly applied when the adversarial sample is generated for the authentication processing (i.e., processing in which the degree of similarity is obtained as a processing result). In the information processing apparatus according to the present example embodiment, however, the adversarial sample suitable for the authentication processing is generated, and it is thus possible to properly assess the risk in the authentication processing.

In addition, when the first information is the first image including the first living body and the second information is the second image including the second living body, the feature quantity is extracted from each of the first image and the second image, and the perturbation is applied on the basis of the degree of similarity between the feature quantities, thereby generating the adversarial sample. In this way, it is thus possible to properly assess the risk in the authentication processing using the image. For example, it is possible to properly assess the risk to an adversarial input, in face authentication using the face image and iris authentication using the iris image.

### 6: Sixth Example Embodiment

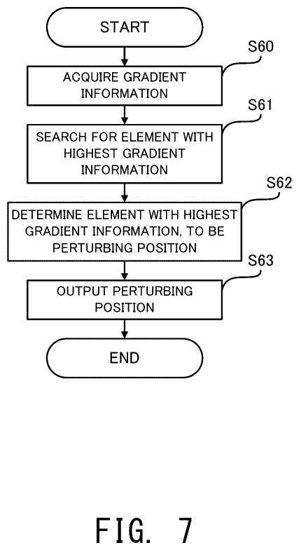

With reference to FIG. 7, an information processing apparatus 6 according to a sixth example embodiment will be described. The sixth example embodiment describes a specific example of an operation when determining a perturbing position in the fifth example embodiment (i.e., an operation corresponding to the step S53 in FIG. 6), and may be the same as the fifth example embodiment in the other parts. For this reason, a part that is different from each of the example embodiments described above will be described in detail below, and a description of the other overlapping parts will be omitted as appropriate.

### 6-1: Perturbing Position Determination Operation Performed by Information processing Apparatus 6

First, with reference to FIG. 7, a flow of a perturbing position determination operation (i.e., an operation when determining the element to be perturbed) by the information processing apparatus 6 according to the sixth example embodiment will be described. FIG. 7 is a flowchart illustrating the flow of the perturbing position determination operation by the information processing apparatus according to the sixth example embodiment.

As illustrated in FIG. 7, in the perturbing position determination operation by the information processing apparatus 6 according to the sixth example embodiment, first, the perturbing position determination unit 211 acquires the gradient information (i.e., the gradient information about the gradient of the degree of similarity between the first information feature quantity and the second information feature quantity) calculated by the gradient information calculation section 515 (step S60). Then, the perturbing position determination unit 211 searches for one element with the highest gradient information, on the basis of the gradient information calculated by the gradient information calculation unit 515 (step S61).

Subsequently, the perturbing position determination unit 211 determines the one element with the highest gradient information obtained as a search result, to be the element to be perturbed (i.e., the perturbing position) (step S62). When there are a plurality of elements with the highest gradient information, the perturbing position determination unit 211 may select one of the plurality of elements and may determine it to be the element to be perturbed. Thereafter, the perturbing position determination unit 211 outputs the information about the element to be perturbed, to the perturbing unit 212 (step S63).

### 6-2: Technical Effect of Information processing Apparatus 6

Next, a technical effect obtained by the information processing apparatus 6 according to the sixth example embodiment will be described.

As described in FIG. 7, in the information processing apparatus 6 according to the sixth example embodiment, one element with the highest gradient information is determined to be the perturbing target. In this way, it is possible to determine the perturbing position, easily and properly, on the basis of the gradient information. Therefore, it is possible to properly generate the adversarial sample and to assess the risk in the authentication processing.

### 7: Seventh Example Embodiment

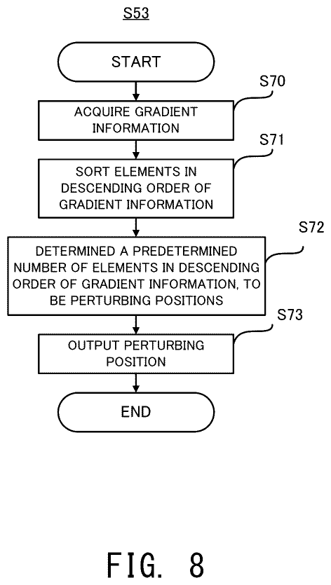

An information processing apparatus 7 according to a seventh example embodiment will be described with reference to FIG. 8. The seventh example embodiment describes a specific example of the perturbing position determining operation as in the sixth example embodiment, and may be the same as the fifth example embodiment in the other parts. For this reason, a part that is different from each of the example embodiments described above will be described in detail below, and a description of the other overlapping parts will be omitted as appropriate.

### 7-1: Perturbing Position Determination Operation Performed by Information processing Apparatus 7

First, with reference to FIG. 8, a flow of a perturbing position operation by the information processing apparatus 7 according to the seventh example embodiment will be described. FIG. 8 is a flowchart illustrating the flow of the perturbing position determination operation by the information processing apparatus according to the seventh example embodiment.

As illustrated in FIG. 8, in the perturbing position determination operation by the information processing apparatus 7 according to the seventh example embodiment, first, the perturbing position determination section 211 acquires the gradient information (i.e., the gradient information about the gradient of the degree of similarity between the first information feature quantity and the second information feature quantity) calculated by the gradient information calculation section 515 (step S70). Then, the perturbing position determination unit 211 sorts the elements in descending order of the gradient information calculated by the gradient information calculating unit 515 (step S71).

Subsequently, the perturbing position determining section 211 determines a predetermined number of elements in descending order of the gradient information, to be the elements to be perturbed (i.e., the perturbing positions) (step S72). Here, the “predetermined number” is the number of the elements to be selected as the perturbing positions, and may be, for example, a value that is arbitrarily settable by a user or the like. For example, when the predetermined number is set to “3”, the perturbing position determining section 211 may determine an element with the highest gradient information, an element with the second highest element, and an element with the third highest element, to be the perturbing positions. Thereafter, the perturbing position determination unit 211 outputs the information about the elements to be perturbed, to the perturbing unit 212 (step S73).

### 7-2: Technical Effect of Information Processing Apparatus 7

Next, a technical effect obtained by the information processing apparatus 7 according to the seventh example embodiment will be described.

As described in FIG. 8, in the information processing apparatus 7 according to the seventh example embodiment, the predetermined number of elements are determined to be the perturbed target in descending order of the gradient information. In this way, it is possible to determine the perturbing position, easily and properly, on the basis of the gradient information. Therefore, it is possible to properly generate the adversarial sample and to assess the risk in the authentication processing.

### 8: Eighth Example Embodiment

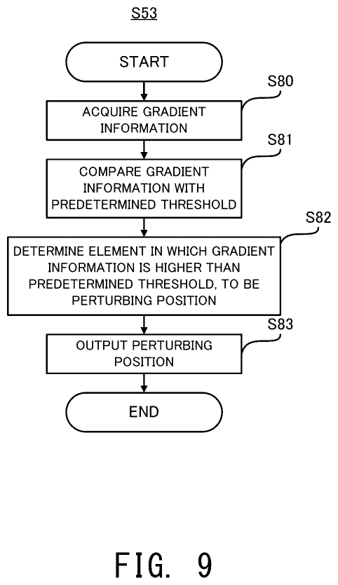

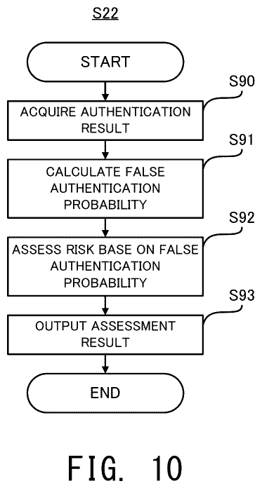

An information processing apparatus 8 according to an eighth example embodiment will be described with reference to FIG. 9. The eighth example embodiment describes a specific example of the perturbing position determination operation, as in the sixth and seventh example embodiments, and may be the same as the fifth example embodiment in the other parts. For this reason, a part that is different from each of the example embodiments described above will be described in detail below, and a description of the other overlapping parts will be omitted as appropriate.

### 8-1: Perturbing Position Determination Operation Performed by Information Processing Apparatus 8

First, with reference to FIG. 9, a flow of a perturbing position operation by the information processing apparatus 8 according to the eighth example embodiment will be described. FIG. 9 is a flowchart illustrating the flow of the perturbing position determination operation by the information processing apparatus according to the eighth example embodiment.

As illustrated in FIG. 9, in the perturbing position determination operation by the information processing apparatus 8 according to the eighth example embodiment, first, the perturbing position determination section 211 acquires the gradient information (i.e., the gradient information about the gradient of the degree of similarity between the first information feature quantity and the second information feature quantity) calculated by the gradient information calculation section 515 (step S80). Then, the perturbing position determination unit 211 compares the gradient information calculated by the gradient information calculating unit 515 with a predetermined threshold (step S81). The “predetermined threshold” here is a threshold set in advance to determine the perturbing position.

Subsequently, the perturbing position determination section 211 determines an element in which the gradient information is higher than the predetermined threshold, to be the element to be perturbed (i.e., the perturbing position) (step S82). Therefore, for example, when it is desired to determine a relatively small number of elements to be the perturbing positions, the predetermined threshold may be set as a higher value. Conversely, when it is desired to determine a relatively large number of elements to be the perturbing positions, the predetermined threshold may be set as a lower value. Thereafter, the perturbing position determination unit 211 outputs the information about the element to be perturbed, to the perturbing unit 212 (step S83).

In the step S82, when there is no gradient information that is lower than the predetermined threshold (i.e., when all the pieces of gradient information are lower than the predetermined threshold), the predetermined threshold may be reset to a lower value, and then, the steps S81 and S82 may be performed again. Alternatively, when there is no gradient information that is lower than the predetermined threshold, the perturbing position may be determined by the method already described in the sixth and seventh example embodiments.

### 8-2: Technical Effect of Information Processing Apparatus 8

Next, a technical effect obtained by the information processing apparatus 8 according to the eighth example embodiment will be described.

As described in FIG. 9, in the information processing apparatus 8 according to the eighth example embodiment, the element in which the gradient information is higher than the predetermined threshold, is determined to be the perturbed target. In this way, it is possible to determine the perturbing position, easily and properly, on the basis of the gradient information.

Therefore, it is possible to properly generate the adversarial sample and to assess the risk in the authentication processing.

### 9: Ninth Example Embodiment

An information processing apparatus 9 according to a ninth example embodiment will be described with reference to FIG. 10. The ninth example embodiment describes a specific example of an operation of risk assessment in the first to eighth example embodiments (i.e., an operation corresponding to the step S22 in FIG. 3), and may be the same as the first to eighth example embodiments in the other parts. For this reason, a part that is different from each of the example embodiments described above will be described in detail below, and a description of the other overlapping parts will be omitted as appropriate.

### 9-1: Risk Assessment Operation

First, with reference to FIG. 10, a flow of a risk assessment operation (i.e., an operation when assessing the risk by using the generated adversarial sample) by the information processing apparatus 9 according to the ninth example embodiment will be described. FIG. 10 is a flowchart illustrating the flow of the risk assessment operation by the information processing apparatus according to the ninth example embodiment.

As illustrated in FIG. 10, in the risk assessment operation performed by the information processing apparatus 9 according to the ninth example embodiment, first, the assessment unit 213 acquires the result of the authentication processing using the adversarial sample (i.e., the perturbed first information) (step S90). Then, the assessment unit 213 calculates a false authentication probability on the basis of the acquired authentication result (step S91). The false authentication probability is a probability that an incorrect authentication result is obtained, and it may be calculated by dividing the number of times of false authentication, by a total number of the authentication, for example. The false authentication may include a successful attack by the adversarial sample (i.e., the perturbed first information).

Subsequently, the assessment unit 213 assesses the risk in the authentication processing on the basis of the calculated false authentication probability (step S92). For example, the assessment unit 213 may determine that the risk is higher as the false authentication probability is higher. Thereafter, the assessment unit 213 outputs the assessment result (step S93). The assessment unit 213 may output the false authentication probability together with the assessment result.

### 9-2: Technical Effect of Information processing Apparatus 9

Next, a technical effect obtained by the information processing apparatus 9 according to the ninth example embodiment will be described.

As described in FIG. 10, in the information processing apparatus 9 according to the ninth example embodiment, the risk is assessed on the basis of the false authentication probability calculated from the authentication result. In this way, it is possible to properly assess the risk that the incorrect authentication result is outputted for the adversarial input.

In each of the example embodiments described above, each of the similarity degree calculation unit 514, the gradient information calculation unit 515, the perturbing position determination unit 211, the perturbing unit 212, and the assessment unit 213 may include a neural network.

### 10: Supplementary Notes

With respect to the example embodiment described above, the following Supplementary Notes are further disclosed.

### [Supplementary Note 1]

An information processing apparatus including:
a perturbing position determination unit that determines an element serving as a perturbing target in first information;
a perturbing unit that applies a perturbation with magnitude based on values of one or more elements surrounding the element serving as the perturbing target, to the element serving as the perturbing target; and
a risk assessment unit that assesses a risk in authentication processing based on a result of the authentication processing of matching the first information to which the perturbation is applied, with second information that is different from the first information.

### [Supplementary Note 2]

The information processing apparatus according to Supplementary Note 1, wherein the perturbing unit determines the magnitude of the perturbation applied to the element serving as the perturbing target such that a difference between a calculated value calculated based on the value of the elements surrounding the element serving as the perturbing target and the magnitude of the perturbation applied to the element serving as the perturbing target is less than or equal to a predetermined value, and applies the perturbation with the magnitude to the element serving as the perturbing target.

### [Supplementary Note 3]

The information processing apparatus according to Supplementary Note 2, wherein the perturbing unit applies a perturbation with magnitude based on a mean value of the elements surrounding the element serving as the perturbing target, to the element serving as the perturbing target.

### [Supplementary Note 4]

The information processing apparatus according to any one of Supplementary Notes 1 to 3, wherein
the first information is a first image including a first living body, and
the second information is a second image including a second living body.

### [Supplementary Note 5]

The information processing apparatus according to any one of Supplementary Notes 1 to 3, further including:
a similarity degree calculation unit that calculates a degree of similarity between a feature quantity of the first information and a feature quantity of the second information; and
a gradient information calculation unit that calculates gradient information indicating a gradient of the degree of similarity, wherein
the perturbing position determination unit determines the element serving as the perturbing target based on the gradient information.

### [Supplementary Note 6]

The information processing apparatus according to Supplementary Note 5, wherein the perturbing position determination unit determines one element with a highest piece of gradient information, to be the element serving as the perturbing target.

### [Supplementary Note 7]

The information processing apparatus according to Supplementary Note 5, wherein the perturbing position determination unit determines a predetermined number of elements in descending order of the gradient information, to be the element serving as the perturbing target.

### [Supplementary Note 8]

The information processing apparatus according to Supplementary Note 5, wherein the perturbing position determination unit determines an element in which the gradient information is greater than a predetermined threshold, to be the element serving as the perturbing target.

### [Supplementary Note 9]

The information processing apparatus according to any one of Supplementary Notes 1 to 3, wherein the risk assessment unit calculates a false authentication probability in the authentication processing and assesses the risk in the authentication processing based on the false authentication probability.

### [Supplementary Note 10]

An information processing method including:
determining an element serving as a perturbing target in first information;
applying a perturbation with magnitude based on values of one or more elements surrounding the element serving as the perturbing target, to the element serving as the perturbing target; and
assessing a risk in authentication processing based on a result of the authentication processing of matching the first information to which the perturbation is applied, with second information that is different from the first information.

### [Supplementary Note 11]

A recording medium on which a computer program that allows at least one computer to execute an information processing method is recorded, the information processing method including:
determining an element serving as a perturbing target in first information;
applying a perturbation with magnitude based on values of one or more elements surrounding the element serving as the perturbing target, to the element serving as the perturbing target; and
assessing a risk in authentication processing based on a result of the authentication processing of matching the first information to which the perturbation is applied, with second information that is different from the first information.

This disclosure is not limited to the examples described above. This disclosure is allowed to be changed, if desired, without departing from the essence or spirit of this disclosure which can be read from the claims and the entire specification. An information processing apparatus, an information processing method, and a recording medium with such changes are also intended to be within the technical scope of this disclosure.

### DESCRIPTION OF REFERENCE CODES

1, 2, 3, 4, 5, 6, 7, 8, 9 Information processing apparatus
11, 211 Perturbing position determination unit
12, 212 Perturbing unit
13, 213 Assessment unit
514 Similarity degree calculation unit
515 Gradient information calculation unit

What is claimed is:

1. An information processing apparatus comprising:
at least one memory that is configured to store instructions; and
at least one processor that is configured to execute the instructions to:
determine an element serving as a perturbing target in first information;
apply a perturbation with magnitude based on values of one or more elements surrounding the element serving as the perturbing target, to the element serving as the perturbing target; and
assess a risk in authentication processing based on a result of the authentication processing of matching the first information to which the perturbation is applied, with second information that is different from the first information.

2. The information processing apparatus according to claim 1, wherein the at least one processor that is configured to execute the instructions to: determine the magnitude of the perturbation applied to the element serving as the perturbing target such that a difference between a calculated value calculated based on the value of the element surrounding the element serving as the perturbing target and the magnitude of the perturbation applied to the element serving as the perturbing target is less than or equal to a predetermined value, and apply the perturbation with the magnitude to the element serving as the perturbing target.

3. The information processing apparatus according to claim 2, wherein the at least one processor that is configured to execute the instructions to apply a perturbation with magnitude based on a mean value of the elements surrounding the element serving as the perturbing target, to the element serving as the perturbing target.

4. The information processing apparatus according to claim 1, wherein
the first information is a first image including a first living body, and
the second information is a second image including a second living body.

5. The information processing apparatus according to claim 1, wherein the at least one processor that is configured to execute the instructions to:
calculate a degree of similarity between a feature quantity of the first information and a feature quantity of the second information; and
calculate gradient information indicating a gradient of the degree of similarity; and
determine the element serving as the perturbing target based on the gradient information.

6. The information processing apparatus according to claim 5, wherein the at least one processor that is configured to execute the instructions to determine one element with a highest gradient information, to be the element serving as the perturbing target.

7. The information processing apparatus according to claim 5, wherein the at least one processor that is configured to execute the instructions to determine a predetermined number of elements in descending order of the gradient information, to be the element serving as the perturbing target.

8. The information processing apparatus according to claim 5, wherein the at least one processor that is configured to execute the instructions to determine an element in which the gradient information is greater than a predetermined threshold, to be the element serving as the perturbing target.

9. The information processing apparatus according to claim 1, wherein the at least one processor that is configured to execute the instructions to calculate a false authentication probability in the authentication processing and assesses the risk in the authentication processing based on the false authentication probability.

10. An information processing method comprising:
determining an element serving as a perturbing target in first information;
applying a perturbation with magnitude based on values of one or more elements surrounding the element serving as the perturbing target, to the element serving as the perturbing target; and
assessing a risk in authentication processing based on a result of the authentication processing of matching the first information to which the perturbation is applied, with second information that is different from the first information.

11. A non-transitory recording medium on which a computer program that allows at least one computer to execute an information processing method is recorded, the information processing method including:
determining an element serving as a perturbing target in first information;
applying a perturbation with magnitude based on values of one or more elements surrounding the element serving as the perturbing target, to the element serving as the perturbing target; and
assessing a risk in authentication processing based on a result of the authentication processing of matching the first information to which the perturbation is applied, with second information that is different from the first information.
